(19) United States
(12) Patent Application Publication
(10) Pub. No.: US 2011/0201272 A1
(43) Pub. Date: Aug. 18, 2011

(54) INTERACTIVE BASE STATION WITH PROCESSOR AND BODIES

(76) Inventor: Jeroen Frederik De Weerd, Valkenburg (NL)

(21) Appl. No.: 12/737,836

(22) PCT Filed: Jul. 28, 2009
(86) PCT No.: PCT/NL2009/050464

§ 371 Date: Apr. 25, 2011

(30) Foreign Application Priority Data
Aug. 25, 2008 (NL) 1035862

(51) Int. Cl. G09B 3/00; H04W 4/02; H04W 88/08

(52) U.S. Cl. 455/41.2; 455/39; 455/91; 434/322

(57) ABSTRACT

The invention relates to a base station (100) provided with a processor and with bodies (1,3). Each body is provided at several outer surfaces thereof with visualisations such that a combination of visualisations can be formed in at least one plane by means of a number of outer surfaces of different bodies. At least a means is furthermore present in each body for enabling the processor to ascertain the position and orientation of each body used in a particular combination. The base station is further provided with a visualisation means (7,9) on which at least a portion of an assignment is printed, which visualisation means is provided with at least a communication means to the processor for communicating to the processor the possible answers to the assignment. The carrying out of the at least one assignment through the formation of an answer by means of the outer surfaces of the bodies with a combination of visualisations in at least one predetermined plane can be checked by the processor.

The invention relates to a base station provided with a processor and with bodies, each body being provided at several outer surfaces thereof with visualisations such that a combination of visualisations can be formed in at least one plane by means of a number of outer surfaces of different bodies.

Such a base station is known per se from Dutch patent NL-1.028.435. FIG. 5 in this patent shows the base station in the form of a storage box, which storage box is provided with a protester for providing the comparatively intelligent bodies with new information, such as new visualisations. As a result of this, a large number of combinations of visualisations can be created by means of the outer surfaces of the bodies independently of the type of bodies: card-shaped or block-shaped.

The comparatively simple processor of the storage box is thus used in particular for transferring the data from a memory medium to the bodies and furthermore possibly for showing the status of the transfer on a display. It is not possible with this processor to check the combination formed by the visualisations of the bodies since this combination is checked by the processors of the bodies themselves.

The bodies known from NL-1.0285.435 are even designed such that they at the same time present a stimulus, such as a sound or an image, to a user for a combination that is to be formed with the visualisations of the bodies. This latter aspect leads to a relatively high manufacturing cost of such an intelligent body. It was further found, from a didactic point of view, that the stimuli are not always satisfactorily transmitted to the users owing to the integration of the output of the stimuli in the bodies themselves and may even lead to confusion, which is a problem especially in the case of relatively young users.

It is accordingly an object of the present invention to provide a comparatively robust base station in which the stimuli are issued in a didactically improved manner.

This object is achieved in the base station according to the invention in that at least one means is present in each body for enabling the processor to ascertain the orientation and position of each body used in a particular combination, while the base station is further provided with a visualisation means on which at least a portion of an assignment is printed, which visualisation means is provided with at least one communication means to the processor for communicating to the processor any answers to said assignment, wherein the carrying out of the at least one assignment, through the formulation of an answer by means of a combination of visualisations on the outer surfaces of the bodies in at least one predetermined plane, can be checked by means of the processor.

Printed visualisation means such as, for example, books have been used from time immemorial in the education of children for didactically proven reasons. A book or printed plate with a figure and an assignment thereon provides little or no interaction with the user because the assignment cannot be checked. The present invention comprises a visualisation means that has been printed separately from the bodies and carries partial or complete visual assignments, while partial or possibly complete assignments can be additionally supported by the base station in a tactile and/or acoustic manner. Such an assignment is to be performed by means of the bodies, which are preferably blocks, and the answer formed by means of the bodies is checked by the processor of the base station. In this manner a user, in particular a child, is offered an interactive base station means of the bodies, with which station a language or arithmetical problems can be treated in an educative manner. The interaction in the base station according to the invention here comprises a step in which part of the assignment is represented by the visualisation means, for example in the form of a drawing. The base station may then ask a supplementary question about the drawing, to which at least one answer is possible. The answers are transmitted to the processor by a communication means such as, for example, a Universal Serial Bus or possibly a wireless Bluetooth link. Once the processor has detected that a correct or incorrect answer has been formulated by means of the bodies in a specific plane, the base station can respond thereto visually by means of light and/or acoustically.

A base station that is sufficiently robust for use by children is developed with the printed visualisation means for displaying an assignment, in contrast to, for example, a comparatively sensitive computer screen. The base station according to the preset invention also aims to alternate the ever more intensive use of the computer, for example a desktop or a laptop, with educative physical objects both in an educational setting and at home.

Although the bodies described in Dutch patent 1 028 435 can be used in the base station according to the present invention, in which case the processors of the bodies are to communicate with the processor of the base station in which the combination formed with the bodies is then (additionally) checked, it is preferable to use less intelligent bodies, i.e. bodies without processor, for the base station according to the present invention. Such bodies without processor are more robust and generally have a longer operational life. In addition, bodies without processor require no batteries and the like. The processor that provides the interaction between a user and the base station is integrated in this base station according to the invention, which base station is provided with an energy source such as a rechargeable battery or can be connected to the mains voltage.

The interactive base station according to the invention is particularly suitable for children, but it may also be used by adults for studying, for example, a foreign language or some other subject.

A special preferred embodiment of the base station according to the present invention is characterised in that the visualisation means is a book or a plate, which book or plate can be detachably fastened to the base station.

In this manner various visualisation means are compatible with the base station according to the present invention. The visualisation means is preferably a book. It is also possible to use a plate or similar object with a drawing printed thereon in the base station according to the present invention. With a book or a detachable plate, a user is actively involved in the process to be carried out by means of the base station according to the present invention by turning a page of the book or fastening a new plate to the base station when the assignments on the open page or relevant plate have been completed or when a user wishes to view and/or perform the assignments of the next page or plate for some other reason.

Since it is possible to use a plurality of detachable books or plates in combination with a single base station according to the present invention, one and the same base station can be used for toddlers with a book or plate designed for toddlers as well as, for example, for ten year olds with books designed for children Of that age. The flexibility of the base station is considerably enhanced by the possibility of using various books in one base station.

The book is preferably provided with more than two pages of assignments and comprises detection means that cooperate with the processor for detecting which pages have been opened by a user. Said detection means are preferably formed by at least one transmitter communicating with the processor such as, for example, an ID tag. An RF-ID tag is comparatively inexpensive and its operational life is comparatively long. The book further comprises a memory to which the processor has access, preferably a comparatively robust flash memory in which the assignments and any supplementary rules of play are stored. The processor has access to the answers in this memory and to the additional instructions accompanying an assignment that is displayed visually at least in pert, such as in the case in which at least one question belonging to the assignment is asked through a loudspeaker controlled by the processor.

The base station is preferably provided with a holder in which the bodies can be positioned. The holder may be integrated in the base station or alternatively it may be detachable. Such a detachable holder may communicate with the processor in the base station, for example in a wireless manner via Bluetooth. The holder can thus be held in a position that is comfortable for a user, which position may be a position separated from the base station during use of the interactive base station according to the present invention.

The bodies may be provided with means that cooperate with the holder, such as passive ID tags on substantially each inner side of an outer surface, which tags are detected by reading means in the holders so that the body in the holder is identified and the orientation of its outer surfaces is recognised by the processor, which can thus detect what answer was formulated. Depending on the holder, additional magnets may be provided at the inner side in the corners of the outer surfaces for determining the orientation of an outer surface.

Alternatively, the bodies may be provided with respective magnets having different characteristic magnetic strengths for identifying a body. The magnetic strength and the position of the single magnet in the body relative to the reading means are then used by the processor for identifying each body and determining the orientation of the body. It is alternatively possible to provide each outer surface of a body with a magnet of a specific strength. If only a single magnet is provided in a body, it will be necessary for all outer surfaces but one of the body to be at least partly enveloped by the holder in order to enable the reading means in the holder and the processor to ascertain the orientation of the body.

It is also possible to provide the bodies with at least one orientation sensor and with at least one transmitter, for example an active RF-ID tag, which transmitter is in communication with the processor such that the orientation of the body determined by the orientation sensor can be communicated to the processor by the transmitter.

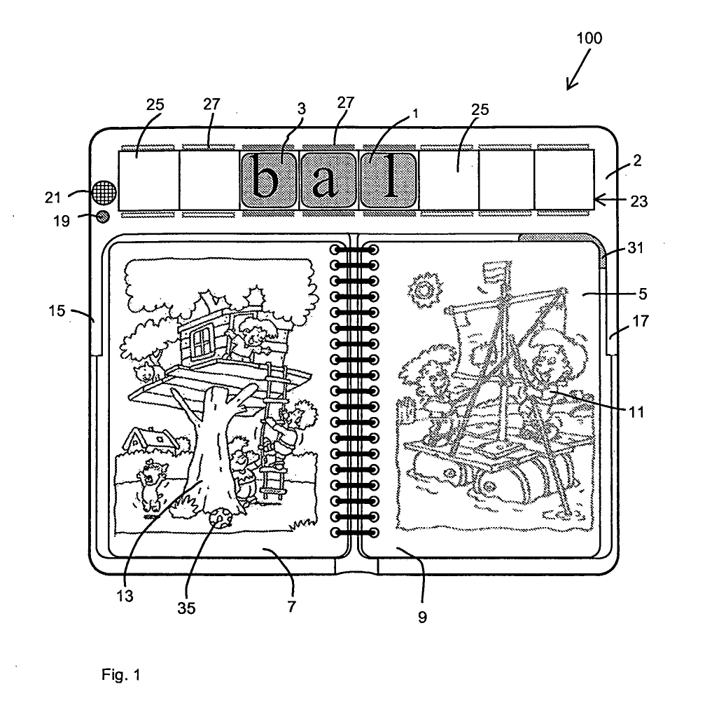

The invention will be described in more detail below with reference to an embodiment, which is not to be regarded as constituting a limitation, and with reference to the accompanying FIG. 1.

FIG. 1 shows a base station 100 according to the present invention. The interactive base station 100 is provided with a processor (not shown) that is located behind the housing 2 of the base station 100 shown in FIG. 1. The base station 100 is further provided with block-shaped bodies 1. Each block-shaped body 1 has six outer surfaces, of which only the topmost outer surface 3 of each block-shaped body 1 is shown in FIG. 1. Several outer surfaces of each body 1 are provided with visualisations, such as the letters b, a, l in the example shown. A combination of letters can be formed with a number of outer surfaces of three bodies 1 in the example shown: bal (Dutch spelling of ‘ball’).

In each body 1 there is at least one means (not shown) present for determining, in cooperation with the processor, the orientation and position of each body 1 used in a combination thus formed. Such a means may be, for example, an orientation sensor that communicates with the processor of the base station 100 via an RF-ID tag or that communicates with the processor of the base station 100 via a processor present in the body; cf. for example the bodies known from NL-1.028.435.

Preferably, however, the bodies 1 of the base station 100 according to the present invention do not comprise a processor. Such simple bodies will be discussed in more detail below.

The base station 100 is further provided with a book 5 that can be detachably fastened thereto. The book 5 is provided with pages 7, 9 and with a covet 10. Drawings 11, 13 are printed on the pages 7, 9 of the book 5, representing part of the assignment to be carried out with the block-shaped bodies 1.

The cover 10 of the book 5 can be clamped to the base station 100 by means of guide members 15, 17 present on either side of the base station 100.

The base station 100 shown further comprises a volume control 19 for adjusting the volume of the loudspeaker 21 and a holder 23 built up from compartments 25, in each of which a body 1 can be positioned. Also present is a lighting unit 27 in the form of energy-efficient light-emitting diodes (LEDs). A headphone connection (not shown) is also provided, so that several base stations according to the invention can be used in a school class without the users hindering each other.

The book 5 is provided with a flash memory (not shown) in which instructions for the processor of the base station 100 and answers to assignments are stored. The processor of the base station is capable of consulting the possible answers to the assignment in the memory of the book 5 by means of a bus such as, for example, a Universal Serial Bus (USB) or a memory card type connection such as a connection between an SD card and a card reader.

The operation of the base station 100 according to the present invention is as follows.

In the book 5 shown in FIG. 1, drawings 11, 13 are present which represent part of an assignment that is to be carried out by a user with the help of the bodies 1. The assignment is fully communicated to the user in that either a printed instruction was given on a previous page or a question is put to the user through the loudspeaker 21. The question or printed instruction may be, for example: “What objects do you see in the picture?” The question to be put is stored in the memory of the book 5 and can be communicated to the processor via the USB link 31. Furthermore, the possible answers can be transferred to a memory (not shown) of the base station 100. It is also possible for the answers to be checked in the memory of the book 5 with the aid of the processor of the base station 100.

One of the objects shown in the drawings 7, 9 is, for example, a ball 35 (Dutch “bal” in the figure). The user may then form the answer “bal” in the holder 23 by placing three bodies 1.

The bodies 1 preferably comprise means (not shown) that cooperate with the compartments 25 for ascertaining in cooperation with the processor the orientation and position of each body 1 used in a combination thus formed. The bodies 1 preferably each comprise a passive RF-ID tag on each side and a magnet in the corner of each side for cooperating with reading means (not shown) in the compartments 25 so as to determine the letter on the upper surface and the orientation of the upper surface 3 of the body 1 as well as the composed combination by means of the processor of the base station 100. The base station 100 subsequently decides whether the letter combination formed by the bodies 1 corresponds to a list of answers retrieved from the memory of the book 5 as belonging to the open pages 7, 9. The pages 7, 9 of the book 5 preferably have RF-ID tags or possibly alternative identification means integrated in them which communicate with the processor of the base station 100. The base station 100 is capable of detecting from the RF-ID tags in the pages 7, 9 which page 7, 9 lies open.

The registration by the processor of the base station 100 of the answer “bal” formed by the bodies 1 and the checking of this answer “bal” against a list of answers accessible to the processor render it possible, for example, to play a suitable sound fragment from the memory of the book in the case of a correct or incorrect answer. Furthermore, the LEDs 27 may colour blue in the case of a correct, but incomplete combination, green in the case of a fully correct combination, and red in the case of an incorrect combination.

Since the rules of play and the instructions are stored in the memory of the book 5 and not in the base station 100, an unlimited number of books 5 can be used with the base station 100.

Letters were shown only on the outer surfaces 3 of the bodies 1, but letters may be provided on the other outer surfaces of the bodies 1 as well, so that words can be formed and checked not only on the upper surface, but also on the side surface. Numbers and arithmetical operators may be shown instead of letters, So that sums can be made, or musical symbols for composing music, etc. Furthermore, a picture to be put together from several bodies may be represented on the bodies 1.

It may further be possible to fasten the holder 23 detachably to the base station 100 such that it can be removed from the base station, a connection link being established between the holder 23 and the processor in the base station 100 via a wire, but preferably in a wireless manner, so that the user can continue to use the holder 23 when it is detached from the base station 100. The data on the orientation and position of the bodies generated by the means of the bodies and/or the holder are then communicated to the processor via said connection link.

Instead of a book 5, a synthetic resin plate (not shown), for example printed with a drawing, may be used as the visualisation means in conjunction with the base station 100.

The following is claimed as invention:

1. A base station provided with a processor and with bodies, each body being provided at several outer surfaces thereof with visualisations such that a combination of visualisations can be formed in at least one plane by means of a number of outer surfaces of different bodies, wherein at least one means is present in each body for enabling the processor to ascertain the orientation and position of each body used in a particular combination, while the base station is further provided with a visualisation means on which at least a portion of an assignment is printed, which visualisation means is provided with at least one communication means to the processor for communicating to the processor any answers to said assignment, and wherein the carrying out of the at least one assignment, through the formulation of an answer by means of a combination of visualisations on the outer surfaces of the bodies in at least one predetermined plane, can be checked by means of the processor.

2. The base station according to claim 1, wherein the visualisation means is a book or a plate, which book or plate can be detachably fastened to the base station.

3. The base station according to claim 2, wherein the book is provided with pages containing at least partial assignments, said book comprising detection means that cooperate with the processor for detecting which pages have been opened by a user.

4. The base station according to claim 3, wherein said detection means comprises at least a transmitter.

5-10. (canceled)

11. The base station according to claim 4 wherein the transmitter comprises an ID tag that communicates with the processor.

12. The base station according to claim 1 wherein the visualisation means is provided with a memory to which the processor has access and in which at least the possible answers for the processor are stored.

13. The base station according to claim 12 wherein the visualisation means is provided with a memory to which the processor has access and in which supplemental instructions for the processor are stored.

14. The base station according to claim 1 wherein the base station is provided with a holder in which the bodies can be positioned.

15. The base station according to claim 14 wherein the holder can be detachably fastened to the base station.

16. The base station according to claim 12 wherein the holder is provided with means that cooperate with the means of the bodies for identifying each body positioned in the holder and identifying the orientation of each body, and wherein the combination of the visualisations on the outer surfaces of the respective bodies in at least one plane, which plane is preferably defined by the upper surfaces of the bodies, can be communicated to the processor by means of the holder.

17. The base station according to claim 1 wherein the communication means is a wireless connection link providing a connection between the memory of a visualisation means and the processor.

18. The base station according to claim 17 wherein the wireless connection link is a Bluetooth link.

19. The base station according to claim 17 wherein the wireless connection link is a bus.

20. The base station according to claim 17 wherein the bus is a Universal Serial Bus (USB).

21. A visualisation means on which is printed at least a portion of an assignment, which visualisation means is provided with a memory and with communication means for communicating with a processor of a base station according to claim 1.
